(19) United States
(12) Patent Application Publication
(10) Pub. No.: US 2015/0330255 A1
(43) Pub. Date: Nov. 19, 2015

(54) ANTI-TORSION ASSEMBLY WITH WEDGE-SHAPED TORQUE BLOCK

(71) Applicant: UNITED TECHNOLOGIES CORPORATION, Hartford, CT (US)

(72) Inventor: Andrew G. Alarcon, Manchester, CT (US)

(21) Appl. No.: 14/443,424

(22) PCT Filed: Dec. 13, 2013
(86) PCT No.: PCT/US13/75022

§ 371 Date: May 18, 2015

Related U.S. Application Data
(60) Provisional application No. 61/761,918, filed on Feb. 7, 2013.

(51) Int. Cl. F01D 25/28; F01D 25/24

(52) U.S. Cl. CPC F01D 25/28; F01D 25/24; F05D 2220/32; F05D 2230/60

(57) ABSTRACT

An anti-torsion assembly for positioning and securing a thermally conforming liner within a fan containment case is provided. The anti-torsion assembly minimizes relative movement of the thermally conforming liner and the fan containment case by providing a wedge shaped torque block and complimentary shaped L-brackets. A method of assembling a fan case assembly is also provided.

### CROSS-REFERENCE TO RELATED APPLICATION

This application is a US National Stage under 35 USC §371 of International Patent Application No. PCT/US13/75022 filed on Dec. 13, 2013 based on U.S. Provisional Patent Application Ser. No. 61/761,918 filed on Feb. 7, 2013.

### FIELD OF THE DISCLOSURE

The subject matter of the present disclosure relates generally to gas turbine engines. More particularly, the subject matter of the present disclosure relates to an anti-torsion assembly comprising a wedge-shaped torque block and complimentary shaped L-brackets which is used to position and secure a thermally conforming liner within a fan containment case of a gas turbine engine.

### BACKGROUND OF THE DISCLOSURE

Gas turbine engines, such as those used on jet aircraft, generally comprise an air inlet, a fan section, a single or multi-stage compressor section, a combustion section downstream of the compressor section, a single or multi-stage turbine section, and an exhaust nozzle. Air entering the air inlet flows through the compressor section and into the combustion section where it provides oxygen for fuel combustion. The hot combustion gases pass through the turbine section and exit the exhaust nozzle, providing a portion of the engine thrust.

The fan section generally comprises fan blades mounted to a hub and enclosed within a fan case assembly. The fan case assembly generally comprises a fan containment case and a thermally conforming liner disposed within the fan containment case. The clearance between the fan blade tips and the thermally conforming liner is generally kept to a minimum for maximum engine efficiency.

To position the thermally conforming liner within the fan containment case and to minimize or eliminate any relative movement of the two concentric parts, a series of spaced apart anti-torsion assemblies may be provided. Each anti-torsion assembly comprises a torque block mounted to an inner diameter surface of the fan containment case and a pair of L-brackets mounted to an outer diameter surface of the thermally conforming liner.

Typically, each pair of L-brackets is positioned onto the thermally conforming liner using a spacer so that, when the spacer is removed, the inner-facing surfaces of the L-brackets are parallel and spaced apart a distance equal to the width of the spacer. The space between the L-brackets functions as a channel for receiving a torque block. The channel and the torque block have a constant width (defined as the dimension in the circumferential direction). The thermally conforming liner is then ready for inserting into the fan containment case so that each torque block extends within the channel, thereby becoming captured between a pair of L-brackets.

The spacer that determines the channel width must be slightly wider than the torque block to allow the thermally conforming liner to be inserted (slid into) into the fan containment case. Consequently, there may be a gap between one or both L-brackets and the corresponding torque block which can result in some rattling. Also, since the channel and the torque block have a constant width, there is no positive stop to prevent the thermally conforming liner from being inserted too far into the fan containment case. As a result, there may be relative movement between the thermally conforming liner and the fan containment case, either rotational movement or movement in the radial direction.

The present disclosure is directed to an anti-torsion assembly comprising a wedge-shaped torque block and complimentary shaped L-brackets which minimizes or eliminates relative movement between the thermally conforming liner and the fan containment case. The present disclosure is also directed to a method of assembling a fan case assembly using the anti-torsion assembly of the disclosure.

### SUMMARY OF THE DISCLOSURE

According to an embodiment of the disclosure, an anti-torsion assembly is provided comprising a torque block and a pair of L-brackets. The torque block has a mounting plate with a surface, two side walls, a forward wall and an aft wall. Each side wall projects from a proximal edge adjacent the surface and terminates in a distal edge. The forward wall extends between the side walls. The aft wall extends between the side walls aft of the forward wall. The side walls have outwardly-opposing side surfaces diverging toward said aft wall.

Each L-bracket has a foot member and a leg member extending from an inner edge of the foot member. The leg member has a forward end and an aft end and an inner-facing surface. The inner-facing surfaces diverge toward the aft ends.

In one aspect of the disclosure the outwardly-opposing side surfaces of the torque block form a torque block axial angle and the inner-facing surfaces of the L-brackets form a bracket axial angle greater than or equal to the torque block axial angle.

In another aspect of the disclosure the outwardly-opposing side surfaces of the torque block also diverge toward the mounting plate, and the inner-facing surfaces of the L-brackets also converge toward the foot members.

In another aspect of the disclosure, each L-bracket inner-facing surface faces a corresponding torque block outwardly-opposing side surface. Each outwardly-opposing side surface forms a first angle of incidence with a first radial line, and each inner-facing surface forms a second angle of incidence with a second radial line which is greater than or equal to the first angle of incidence.

The L-brackets 72 may be separate, individual pieces. Alternatively, the L-brackets may form part of a single unitary L-bracket member in which the L-brackets 72 are mounted to a bracket plate.

When in use the torque block is affixed to a fan containment case, and the L-brackets are affixed to a thermally conforming liner disposed within the fan containment case. Each L-bracket inner-facing surface faces one of the side surfaces of the torque block.

In another aspect of the disclosure an anti-torsion assembly is provided in which the torque block has a mounting plate with a surface, two side walls, each side wall projecting from a proximal edge adjacent the surface and terminating in a distal edge, a forward wall extending between the side walls, and an aft wall extending between the side walls aft of the forward wall. The side walls having outwardly-opposing side surfaces diverge toward the mounting plate.

A pair of L-brackets may be provided in which each L-bracket has a foot member and a leg member extending from an inner edge of the foot member, the leg member having a forward end and an aft end and an inner-facing surface. The inner-facing surfaces converge toward the foot members.

In another aspect of the disclosure each L-bracket inner-facing surface faces a corresponding outwardly-opposing side surface of the torque block. Each outwardly-opposing side surface forms a first angle of incidence with a first radial line. Each inner-facing surface forms a second angle of incidence with a second radial line that is greater than or equal to the first angle of incidence.

As in earlier embodiments, the L-brackets may be separate, individual pieces, or part of a single unitary L-bracket member having a mounting plate on which the L-brackets are mounted.

The torque block may be affixed to a fan containment case. The L-brackets may be affixed to a thermally conforming liner disposed within the fan containment case. The inner-facing surface of each L-bracket faces one of the side surfaces of the torque block.

In still another embodiment a method of assembling a fan case assembly having an upstream end and a downstream end is provided. The method comprises the steps of: (a) mounting multiple torque blocks onto an inner diameter surface of a fan containment case having an upstream end and a downstream end corresponding to the fan case assembly upstream and downstream ends, each torque block comprising a mounting plate with a surface, two side walls, each side wall projecting from a proximal edge adjacent the surface and terminating in a distal edge, a forward wall extending between the side walls, an aft wall extending between the side walls aft of the forward wall, the side walls having outwardly-opposing side surfaces diverging toward the fan containment case downstream end; (b) positioning multiple pairs of L-brackets onto an outer diameter surface of a thermally conforming liner having an upstream end and a downstream end corresponding to the fan case assembly upstream and downstream ends, each L-bracket having an inner-facing surface, each pair of L-brackets being positioned so that they abut a spacer with their inner-facing surfaces diverging toward the thermally conforming liner downstream end; (c) securing the L-brackets to the thermally conforming liner; (d) removing the spacers to create a channel between each pair of L-brackets; and (e) inserting the thermally conforming liner into the fan containment case so that the torque blocks extend into the channels. The multiple torque blocks may be secured to the fan containment case in a circumferentially spaced apart relationship.

Although the different examples described herein may have the specific components shown in the illustrations, embodiments of this disclosure are not limited to those particular combinations of components. It is possible to use some of the components or features from one of the examples in combination with features or components from another one of the examples.

### BRIEF DESCRIPTION OF THE DRAWINGS

So that the manner in which the concepts of the present disclosure recited herein may be understood in detail, a more detailed description is provided with reference to the embodiments illustrated in the accompanying drawings. It is to be noted, however, that the accompanying drawings illustrate only certain embodiments and are therefore not to be considered limiting of the scope of the disclosure, for the concepts of the present disclosure may admit to other equally effective embodiments. Moreover, the drawings are not necessarily to scale, emphasis generally being placed upon illustrating the principles of certain embodiments.

Thus, for further understanding of these concepts and embodiments, reference may be made to the following detailed description, read in connection with the drawings in which:

FIG. 1 is a longitudinal sectional view of an exemplary gas turbine engine;

FIG. 2 is a perspective view of an embodiment of a fan case assembly;

FIG. 3 is a forward-looking aft section view of the fan case assembly of FIG. 2;

FIG. 4 is a cross-sectional view of the fan case assembly of FIG. 3 taken along line 4-4 of FIG. 3;

FIG. 5 is an enlarged view of a portion of the fan case assembly of FIG. 4;

FIG. 6 is a perspective view of a torque block;

FIG. 7A is a perspective view of a pair of L-brackets mounted to a thermally conforming liner;

FIG. 7B is a perspective view of a pair of L-brackets mounted to a bracket plate that is mounted to a thermally conforming liner;

FIG. 8 is a partial perspective view of a thermally conforming liner just before it is inserted within a fan containment case; and

FIG. 9 is an axial view of an embodiment of an anti-torsion assembly taken along line 8-8 of FIG. 5.

### DETAILED DESCRIPTION

In the disclosure that follows certain relative positional terms are used such as “forward”, “aft”, “upper”, “lower”, “above”, “below”, “inner”, “outer” and the like. These terms are used with reference to the normal operational attitude of a jet engine and should not be considered otherwise limiting. The forward end of a jet engine generally refers to the air inlet end and the aft end generally refers to the exhaust end. Also, “radially outward” generally refers to a direction away from the engine center line while “radially inward” refers to a direction toward the engine center line.

The present disclosure relates to an anti-torsion assembly comprising a wedge-shaped torque block and complimentary shaped L-brackets used for positioning and securing a liner within a fan containment case of a gas turbine engine. The present disclosure also relates to a method of assembling and repairing a fan case assembly using the anti-torsion assembly of the present disclosure.

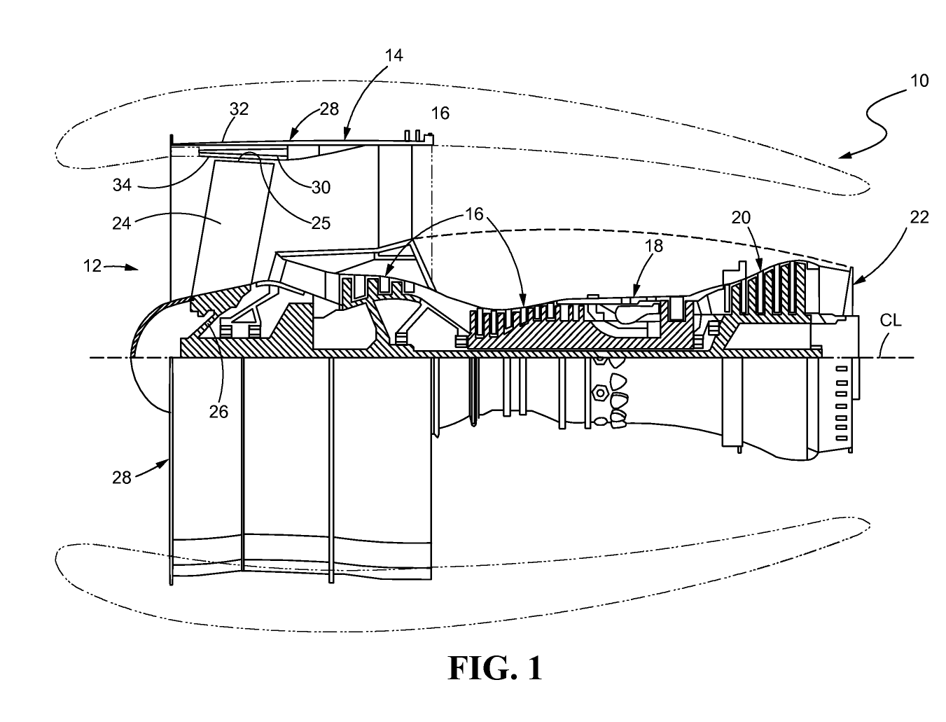

Turning to the figures, FIG. 1 is a longitudinal sectional view of an exemplary gas turbine engine 10. The gas turbine engine 10 comprises an air inlet 12, a fan section 14, a single or multi-stage compressor section 16, a combustion section 18 downstream of the compressor section 16, a single or multi-stage turbine section 20, and an exhaust nozzle 22, all centered around an engine center line CL. Air entering the air inlet 12 flows through the compressor section 16 and into the combustion section 18 where it provides oxygen for fuel combustion. The hot combustion gases pass through the turbine section 20 and exit the exhaust nozzle 22, providing a portion of the engine's thrust.

The fan section 14 generally comprises fan blades 24 mounted to a hub 26 and enclosed within a fan case assembly 28. The fan case assembly (FCA) 28 comprises a thermally conforming liner (TCL) 30 disposed within a fan containment case 32. The clearance between the fan blade tips 25 and the inner diameter surface 34 of the thermally conforming liner 30 is generally kept to a minimum for maximum engine efficiency.

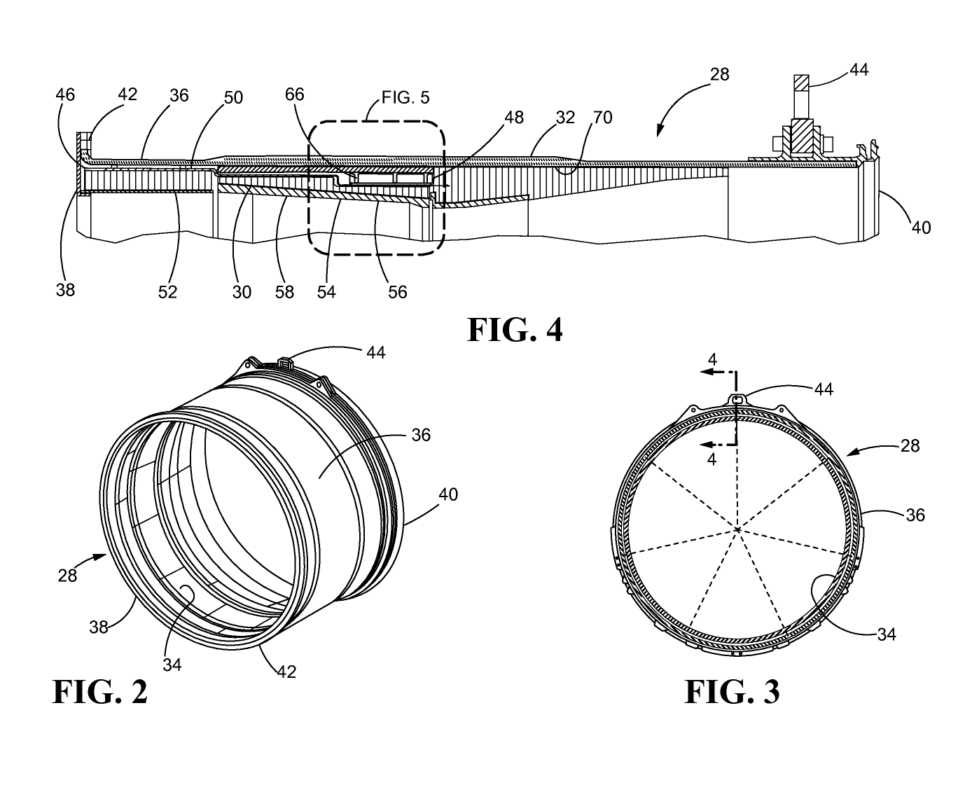

FIG. 2 is a perspective view of an embodiment of a fan case assembly 28, and FIG. 3 is a forward-looking aft section view of the fan case assembly 28 of FIG. 2. The fan case assembly 28 has an inner diameter surface 34 (which is the same as the inner diameter surface 34 of the TCL), an outer diameter surface 36 (which is the same as the outer diameter surface 36 of the fan containment case 32), an upstream end 38 and a downstream end 40. The fan case assembly 28 generally comprises a radially outwardly projecting flange 42 near the upstream end 38 and may also comprise a mounting ring structure 44 near the downstream end 40.

FIG. 4 is a cross-sectional view of the fan case assembly 28 of FIG. 3 taken along line 4-4 to show more detail. The thermally conforming liner 30 is substantially cylindrical and extends from an upstream end 46 (adjacent the upstream end 38 of the fan case assembly) to a downstream end 48, and may comprise progressively radially inwardly staggered sections on its outer diameter surface 50. The thermally conforming liner 30 forms an annular structure surrounding the fan blades 24.

Proximate the upstream end 46 of the thermally conforming liner 30 is a forward acoustic liner 52 formed of honeycomb or other suitable material. Downstream of the acoustic liner 52 is an abradable liner assembly 54 including an abradable rub material 56 having an inboard surface 58 in close proximity to the fan blade tips 25 which are shown in FIG. 1.

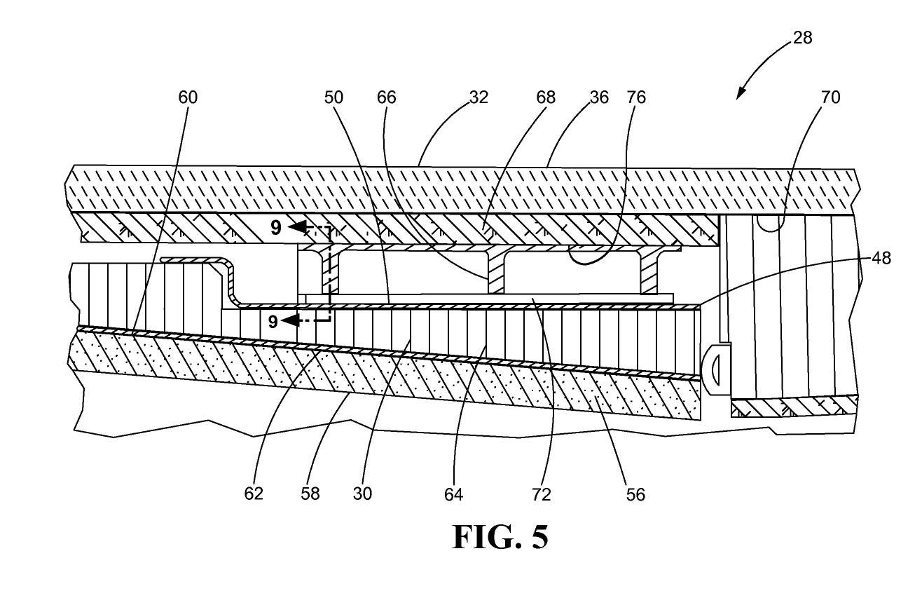

FIG. 5 is an enlarged view of a portion of the fan case assembly 28 of FIG. 4. The radially outboard surface 60 of the abradable rub material 56 is mounted to an aluminum septum 62. The aluminum septum 62 forms the inboard liner of a wedge honeycomb structure 64.

A series of torque blocks 66 are mounted to a liner such as a ballistic liner 68 which in turn is mounted to an inner diameter surface 70 of the fan containment case 32. Alternatively, the torque blocks 66 may be mounted directly to the inner diameter surface 70 of the fan containment case 32. An equal number of pairs of L-brackets 72, only one of which is shown in part in FIG. 5, are mounted onto the outer diameter surface 50 of the thermally conforming liner 30 radially opposite the torque block 66. The function of the torque blocks 66 and L-brackets 72 will now be explained.

Each torque block 66 and pair of L-brackets 72 form part of an anti-torsion assembly 74. The anti-torsion assemblies 74 help position the thermally conforming liner 30 with respect to the fan containment case 32 and eliminate or minimize any relative movement of the two components. Each anti-torsion assembly 74 comprises a torque block 66 mounted to the inner diameter surface 70 of the fan containment case 32 or to the inner diameter surface 76 of the ballistic liner 68 and a pair of L-brackets 72 mounted to the outer diameter surface 50 of the thermally conforming liner 30. During assembly of the fan section 14, the thermally conforming liner 30 is slipped into the fan containment case 32 and positioned and locked into place by the anti-torsion assemblies 74. The anti-torsion assemblies 74 function by constraining (capturing) each torque block 66 within a pair of L-brackets 72, thereby limiting relative movement of the thermally conforming liner 30 with respect to the fan containment case 32.

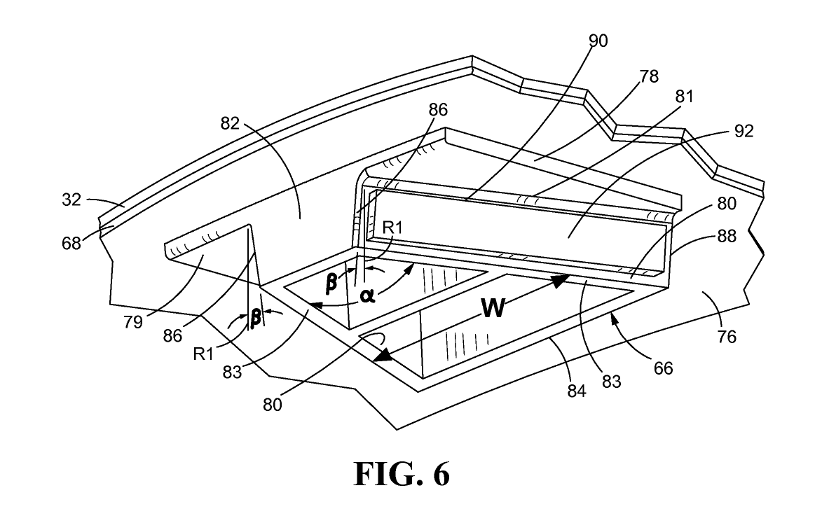

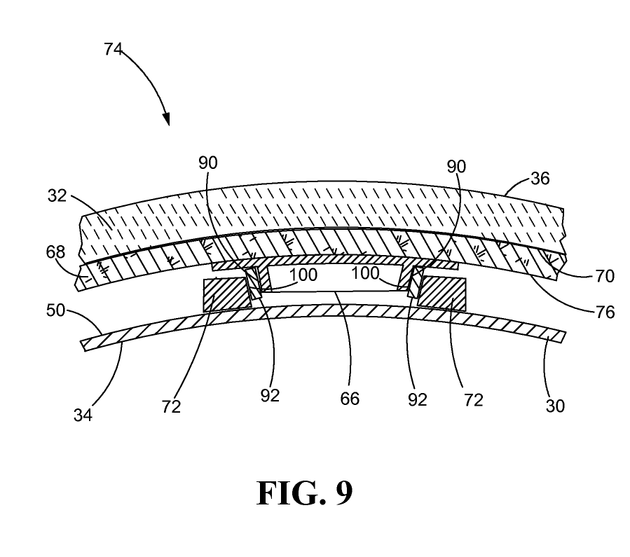

FIG. 6 is a perspective view of an embodiment of a torque block 66. The torque block 66 may comprise a mounting plate 78, two side walls 80, a forward wall 82 and an aft wall 84. The mounting plate 78 may be attached to the inner diameter surface 76 of the ballistic liner 68, and may be slightly curved to conform to the shape of the ballistic liner 68 and fan containment case 32. The forward wall 82 extends between and is connected to the side walls 80 along forward edges 86. The aft wall 84 extends between the side walls 80 aft of the forward wall 82 and is connected to the side walls 80 along aft edges 88. The side walls 80, forward wall 82 and aft wall 84 extend downward from and may be integrally formed with or affixed to the mounting plate 78. Each side wall 80 projects from a proximal edge 81 adjacent the mounting plate 78 to a distal edge 83. The side walls 80 have outwardly-opposing side surfaces 90 which face the L-brackets 72 when the L-brackets 72 and the torque block 66 are brought into axial and circumferential alignment as shown in FIG. 9. The outwardly-opposing side surfaces 90 are so called because they face away from each other. The outwardly-opposing side surfaces 90 may be flat or any suitable shape.

The torque block 66 may carry wear pads 92 on its outwardly-opposing side surfaces 90. Alternatively, wear pads may be carried on the L-brackets 72.

In one aspect of the disclosure, the torque block 66 is wedged shaped in the axial direction (i.e., the direction parallel to the engine center line CL). That is, the side walls 80 (and thus the outwardly-opposing side surfaces 90) are not parallel in the axial direction, but instead diverge (become farther apart) toward the aft wall 84 to form a torque block axial angle (designated “α” in FIG. 6). The circumferential width of the torque block 66, i.e., the width of the torque block 66 in the circumferential direction, or the distance between the outwardly-opposing side surfaces 90 (designated “W” in FIG. 6), increases in the aft direction, and thus the aft wall 84 is wider than the forward wall 82.

In another aspect of the disclosure, the torque block 66 is wedged shaped in the radial direction (perpendicular to the engine center line). That is, the outwardly-opposing side surfaces 90 diverge toward the mounting plate 78, each forming an angle of incidence (designated as “β” in FIG. 6) with respect to a first radial line R1, where the first radial line R1 runs perpendicular to and intersects the mounting plate surface 79 along the proximal edge 81 of the side wall 80. In effect, the side walls 80 converge toward their distal edges 83, and the circumferential width W of the torque block 66 increases toward the mounting plate 78 (in the radial outward direction).

In another aspect of the disclosure, the torque block 66 has a compound wedge shape, that is, a wedge shape in both the axial direction and the radial direction as described in the two preceding paragraphs. The circumferential width W of the torque block 66 in this aspect varies in both dimensions.

It should be understood that the torque block side walls 80 need not be symmetrical with respect to a radial plane (i.e., a plane coextensive with the engine center line CL) bisecting the torque block 66. That is, one torque block side wall 80 may form a different angle with such a radial plane than the other side wall 80, but the sum of the two “radial plane” angles will be equal to the torque block axial angle α by definition. Likewise, the torque block side walls 80 need not be symmetrical in the radial direction. That is, they may have different angles of incidence β.

It should be further understood that the side walls 80 (and thus the outwardly-opposing side surfaces 90) may be parallel in the axial direction, in which case the torque block angle α would be zero. Likewise, the angle of incidence β of one or both side walls 80 (and thus the outwardly-opposing side surfaces 90) may be zero. If the angle of incidence β of both side walls 80 is zero, then both side walls 80 lie along radial planes.

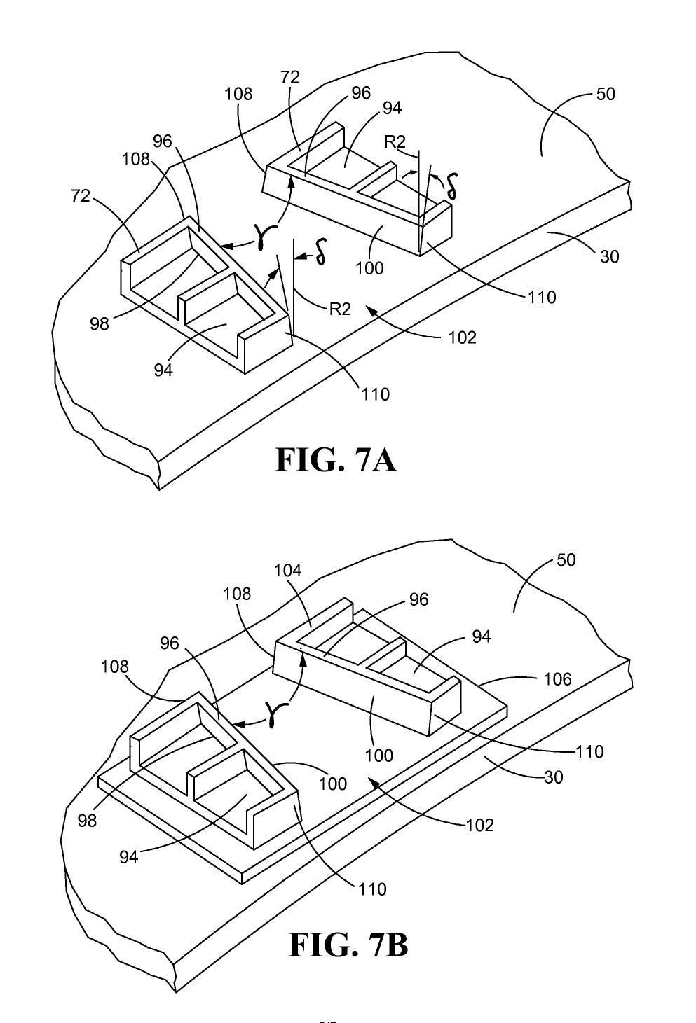

The L-brackets 72 may be manufactured as individual pieces as shown in FIG. 7A or as a single piece as shown in FIG. 7B. FIG. 7A is a perspective view of a pair of exemplary L-brackets 72 mounted to a thermally conforming liner 30. Each L-bracket 72 may comprise a foot member 94 for mounting the L-bracket 72 to the thermally conforming liner 30 and a leg member 96 extending substantially radially outward from an inner edge 98 of the foot member 94 and having a forward end 108 and an aft end 110. Each leg member 96 has an inner-facing surface 100. The inner-facing surfaces 100 may be flat or any shape that is complimentary to the shape of the outwardly-opposing side surfaces 90 of the torque block 66. Because the foot members 94 are mounted to the thermally conforming liner 30, they may be slightly curved to conform to the shape of the thermally conforming liner 30.

The bracket inner-facing surfaces 100 define the side walls of a channel 102, and the thermally conforming liner 30 defines the bottom wall or floor of the channel 102. When mounted to a thermally conforming liner 30 that has then been inserted into a fan containment case 32 as shown in FIG. 9, the inner-facing surfaces 100 face the torque block 66 and cooperate with (such as by abutting) the outwardly-opposing side surfaces 90 of the torque block 66 to prevent or minimize the relative movement of the fan containment case 32 and the thermally conforming liner 30.

FIG. 7B is a perspective view of an L-bracket member 104, comprising a pair of L-brackets 72 mounted to a bracket plate 106 which in turn is mounted to a thermally conforming liner 30. As in the two piece design, each L-bracket 72 may comprise a foot member 94 and a leg member 96 extending substantially orthogonally and radially outward from an inner edge 98 of the foot member 94, each leg member 96 having an inner-facing surface 100. Like the embodiment shown in FIG. 7A, the bracket inner-facing surfaces 100 define the side walls of a channel 102. The bracket plate 106 defines the bottom wall or floor of the channel 102. Because the bracket plate 106 is mounted to the thermally conforming liner 30, it may be slightly curved to conform to the shape of the thermally conforming liner 30.

Making each pair of L-brackets 72 as two pieces (FIG. 7A) minimizes weight since there is no bracket plate. But making each pair of L-brackets 72 as single unitary member 104 (FIG. 7B) with a bracket plate 106 halves the number of pieces that have to be affixed to the thermally conforming liner 30, and thus reduces the complexity of the anti-torsion assemblies 74. Also, manufacturing the L-brackets 72 as a single piece improves tolerances. Since the L-brackets 72 in an L-bracket member 104 are manufactured together and positioned together on the thermally conforming liner 30, there is only one positioning tolerance and one machine tolerance (versus two independent positioning tolerances and two independent machine tolerances with separate individual L-brackets 72).

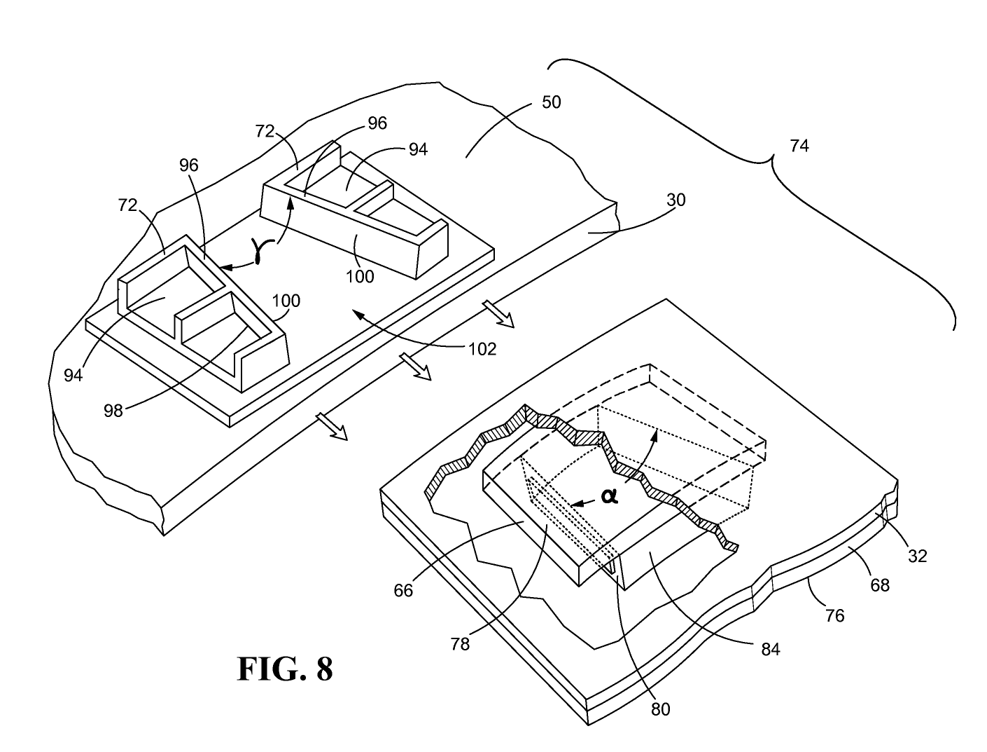

FIG. 8 is a partial perspective view of a thermally conforming liner 30 just before it is inserted within a fan containment case 32. FIG. 9 is a partial axial view of a thermally conforming liner 30 after being inserted within a fan containment case 32. The L-brackets 72 have been positioned on the thermally conforming liner 30 and have been secured to its outer diameter surface 50. The torque block 66 may be secured to the inner diameter surface 76 of the ballistic liner 68 which in turn is mounted to an inner diameter surface 70 of the fan containment case 32.

The L-brackets 72 may be complimentary shaped with respect to the torque block. In one aspect, the inner-facing surfaces 100 of the L-brackets 72 diverge toward the aft ends 110 of the leg members 96. In another aspect, the inner-facing surfaces 100 diverge to form a bracket axial angle γ greater than or equal to the torque block axial angle α. In another aspect, the bracket axial angle γ is the same as the torque block axial angle α, thereby providing a channel 102 into which the torque block 66 fits snugly.

In another aspect related to radial orientation, the inner-facing surfaces 100 converge toward the foot members 94. In another aspect, each inner-facing surface 100 forms a second angle of incidence (designated as “δ” in FIG. 7A) with respect to a second radial line R2, where the second radial line R2 runs perpendicular to and intersects the foot member 94 along its inner edge 98, and the second angle of incidence δ is greater than or equal to the first angle of incidence β of the corresponding outwardly-opposing side surface 90. In another aspect, the second angle of incidence δ equals the first angle of incidence β. In this way the thermally conforming liner 30 can be inserted within the fan containment case 32 until the torque block 66 fits snugly within the channel 102 between the L-brackets 72, with its outwardly-opposing side surfaces 90 abutting at least a portion of the bracket inner-facing surfaces 100. In another aspect, after insertion of the thermally conforming liner 30 into the fan containment case 32, the inner-facing surfaces 100 of the L-brackets 72 are substantially parallel and adjacent to the outwardly-opposing side surfaces 90 of the torque block 66.

When the L-brackets 72 are brought into axial and circumferential alignment with the torque block 66 as shown in FIG. 9, there may be no gaps or very small gaps on either side of the torque block 66 between the torque block 66 and the L-brackets 72. The gaps are not necessarily equal due to tolerances and, in practice, the L-brackets 72 may abut one or the other of the outwardly-opposing side surfaces 70 of the torque block 66.

As long as the circumferential width W of the torque block 66 at its aft wall 84 is greater than the minimum width of the channel 102 between the L-brackets 72, the torque block 66 will act as a stop to prevent the thermally conforming liner 30 from being inserted too far into the fan containment case 32.

The torque block 66 and the L-brackets 72 may be made from aluminum or any suitable material. The wear pads 92, regardless of whether they are located on the torque block 66 (as shown in FIGS. 6 and 9) or on the L-brackets 72, may be made of any light, low friction, wear resistant material that can be bonded to metal, including but not limited to CP-0664 fiber-reinforced composite fabric and polytetraflouroethylene (PTFE), both available commercially from E.I. DuPont de Nemours and Company.

In another aspect of the disclosure a method of assembling a fan case assembly is provided. The method may comprise the following steps: Multiple torque blocks 66 are mounted to the inner diameter surface 70 of the fan containment case 32. That is, the torque blocks 66 are mounted to a structure, such as a ballistic liner 68 or fan containment case 32, so that the torque blocks 66 are in stationary relationship with the fan containment case 32.

The pairs of L-brackets 72 are positioned onto an outer diameter surface 50 of a thermally conforming liner 30 using spacers so that the inner-facing surfaces 100 abut the spacer, and then the L-brackets 72 are bonded or otherwise secured to the thermally conforming liner 30. After bonding of the L-brackets 72, the spacers are removed to create a channel 102 between the L-brackets 72. In another aspect, each pair of L-brackets 72 may be made as a single unitary L-bracket member 104, with the brackets 72 defining a channel 102, and the L-bracket members 104 then secured to the thermally conforming liner 30. The thermally conforming liner 30 is then ready for inserting into the fan containment case 32 so that each torque block 66 extends within a channel 102, thereby becoming captured between a pair of L-brackets 72.

Referring to FIG. 9, due to the compound wedge shape of the torque block 66 and the complimentary shape of the L-brackets 72 in the depicted embodiment, each torque block 66 is wedged against the L-brackets 72 in both the axial direction and the radial direction.

Wedging the torque block 66 against the L-brackets 72 in the axial direction creates a positive stop whereby the thermally conforming liner 30 is prevented from moving any further in the axial direction. Once the forward section of the thermally conforming liner 30 is bonded to the fan containment case 32, the thermally conforming liner 30 is completely captured by the fan containment case 32 and thus prevented from moving relative to the fan containment case 32.

Wedging the torque block 66 against the L-brackets 72 in the axial direction helps center the thermally conforming liner 30 with respect to the fan containment case 32. Because there are gaps between the L-brackets 72 and torque blocks 66 in current anti-torsion assemblies, there is a tendency of the thermally conforming liner 30 to “droop” slightly as it is being installed within a fan containment case 32, especially at the aft end. The compound wedge configuration of the wedge shaped torque block 66 and the complimentary shape of the L-brackets 72 causes the thermally conforming liner 30 to be centered as it is dropped inside the fan containment case 32.

Wedging the torque block 66 against the L-brackets 72 in the radial direction allows thermal growth and shrinkage of the thermally conforming liner 30. The wedge shape of the torque block 66 and L-brackets 72 are such that the angles allow the radial and circumferential growth and shrinkage of the thermally conforming liner 30 within a substantially thermally rigid composite fan containment case 32 without causing binding or interference between the two concentric components.

Finally, wedging the torque block 66 against the L-brackets 72 can eliminate an engine part, because the bumper that is sometimes located between the thermally conforming liner 30 and the ice impact liner will not be required.

### APPLICATIONS

The disclosed apparatus and method of assembly are intended for use in jet engines and, specifically, turbofan jet engines. The disclosed apparatus and method may be applicable in any situation where relative movement of the thermally conforming liner and fan containment case is an issue.

While the present disclosure has been shown and described in terms of one or more exemplary embodiments, it will be understood by one skilled in the art that various changes in detail may be effected therein without departing from the spirit and scope of the disclosure as defined by claims that may be supported by the written description and drawings. Further, where these exemplary embodiments (and other related derivations) are described with reference to a certain number of elements it will be understood that other exemplary embodiments may be practiced utilizing either less than or more than the certain number of elements.

What is claimed is:

1. An anti-torsion assembly comprising:
a torque block having a mounting plate with a surface, two side walls, each side wall projecting from a proximal edge adjacent the surface and terminating in a distal edge, a forward wall extending between the side walls, an aft wall extending between the side walls aft of the forward wall, the side walls having outwardly-opposing side surfaces diverging toward said aft wall;
a pair of L-brackets, each L-bracket having a foot member and a leg member extending from an inner edge of the foot member, the leg member having a forward end and an aft end, each leg member having an inner-facing surface, the inner-facing surfaces diverging toward the aft ends.

2. The anti-torsion assembly of claim 1 wherein:
the outwardly-opposing side surfaces form a torque block axial angle; and
the inner-facing surfaces form a bracket axial angle greater than or equal to the torque block axial angle.

3. The anti-torsion assembly of claim 2 wherein:
the inner-facing surfaces form a bracket axial angle equal to the torque block axial angle.

4. The anti-torsion assembly of claim 1 wherein:
the outwardly-opposing side surfaces diverge toward the mounting plate; and
the inner-facing surfaces converge toward the foot members.

5. The anti-torsion assembly of claim 1 wherein:
each inner-facing surface faces a corresponding outwardly-opposing side surface;
each outwardly-opposing side surface forms a first angle of incidence with a first radial line; and
each inner-facing surface forms a second angle of incidence with a second radial line greater than or equal to the first angle of incidence.

6. The anti-torsion assembly of claim 5 wherein:
each inner-facing surface forms the same angle of incidence as its corresponding outwardly-opposing side surface.

7. The anti-torsion assembly of claim 1 wherein:
the L-brackets are separate, individual pieces.

8. The anti-torsion assembly of claim 1 wherein:
the L-brackets form part of a single unitary L-bracket member.

9. The anti-torsion assembly of claim 8 wherein:
the L-brackets are mounted to a bracket plate.

10. The anti-torsion assembly of claim 1 wherein:
the torque block is affixed to a fan containment case; and
the L-brackets are affixed to a thermally conforming liner disposed within the fan containment case;
wherein each inner-facing surface faces one of the side surfaces of the torque block.

11. An anti-torsion assembly comprising:
a torque block having a mounting plate with a surface, two side walls, each side wall projecting from a proximal edge adjacent the surface and terminating in a distal edge, a forward wall extending between the side walls, an aft wall extending between the side walls aft of the forward wall, the side walls having outwardly-opposing side surfaces diverging toward the mounting plate;
a pair of L-brackets, each L-bracket having a foot member and a leg member extending from an inner edge of the foot member, the leg member having a forward end and an aft end, each leg member having an inner-facing surface, the inner-facing surfaces converging toward the foot members.

12. The anti-torsion assembly of claim 11 wherein:
each inner-facing surface faces a corresponding outwardly-opposing side surface;
each outwardly-opposing side surface forms a first angle of incidence with a first radial line; and
each inner-facing surface forms a second angle of incidence with a second radial line greater than or equal to the first angle of incidence.

13. The anti-torsion assembly of claim 12 wherein:
each inner-facing surface forms the same angle of incidence as its corresponding outwardly-opposing side surface.

14. The anti-torsion assembly of claim 11 wherein:
the L-brackets are separate, individual pieces.

15. The anti-torsion assembly of claim 11 wherein:
the L-brackets are part of a single unitary L-bracket member.

16. The anti-torsion assembly of claim 15 wherein:
the L-brackets are mounted to a bracket plate.

17. The anti-torsion assembly of claim 11 wherein:
the torque block is affixed to a fan containment case; and
the L-brackets are affixed to a thermally conforming liner disposed within the fan containment case;
wherein each inner-facing surface faces one of the side surfaces of the torque block.

18. A method of assembling a fan case assembly having an upstream end and a downstream end, the method comprising the steps of:
(a) mounting multiple torque blocks onto an inner diameter surface of a fan containment case having an upstream end and a downstream end corresponding to the fan case assembly upstream end and downstream end, each torque block comprising a mounting plate with a surface, two side walls, each side wall projecting from a proximal edge adjacent the surface and terminating in a distal edge, a forward wall extending between the side walls, an aft wall extending between the side walls aft of the forward wall, the side walls having outwardly-opposing side surfaces diverging toward the fan containment case downstream end;
(b) positioning multiple pairs of L-brackets onto an outer diameter surface of a thermally conforming liner having an upstream end and a downstream end corresponding to the fan case assembly upstream and downstream ends, each L-bracket having an inner-facing surface, each pair of L-brackets being positioned so that they abut a spacer with their inner-facing surfaces diverging toward the thermally conforming liner downstream end;
(c) securing the L-brackets to the thermally conforming liner;
(d) removing the spacers to create a channel between each pair of L-brackets; and
(e) inserting the thermally conforming liner into the fan containment case so that the torque blocks extend into the channels.

19. The method of claim 18 wherein:
the multiple torque blocks are secured to the fan containment case in a circumferentially spaced apart relationship.
